(19) United States
(12) Patent Application Publication
(10) Pub. No.: US 2017/0185537 A1
(43) Pub. Date: Jun. 29, 2017

(54) DATA STORAGE DEVICE AND CONTROL METHOD THEREOF

(71) Applicant: APACER TECHNOLOGY INC., New Taipei City (TW)

(72) Inventors: YIN-CHUAN LIAO, New Taipei City (TW); ZONG-HAN YANG, New Taipei City (TW)

(21) Appl. No.: 15/014,198

(22) Filed: Feb. 3, 2016

(30) Foreign Application Priority Data
Dec. 23, 2015 (TW) 104143288

(51) Int. Cl. G06F 12/14; G06F 3/06

(52) U.S. Cl. CPC G06F 12/1458; G06F 3/0622; G06F 3/0637; G06F 3/064; G06F 3/0679; G06F 2212/1052

(57) ABSTRACT

A data storage device includes a physical storage unit, an authentication unit and a control unit. The authentication unit has a unique identification code. The control unit is electrically connected with the physical storage unit and configured to receive an identification command corresponding to the unique identification code. When the control unit receives the identification command, the control unit generates a logical block starting address and an available space according to the identification command, and determines a specified physical accessing block of plural physical accessing blocks of the physical storage unit according to the logical block starting address and the available space. The logical block starting address is a positive integer. In addition, a size of the physical accessing block is smaller than or equal to a size of the physical storage unit.

### FIELD OF THE INVENTION

The present invention relates to a data storage device and a control method thereof, and more particularly to a secure and flexible data storage device and a control method thereof.

### BACKGROUND OF THE INVENTION

With human civilization of science, technology and modernization, the data storage technologies have been well and maturely established. Consequently, a variety of data storage devices have been introduced into the market. For example, a solid state drive (SSD) is one of the mainstream products of the data storage devices.

Conventionally, the solid state drive is packaged in a standard 2.5-inch disk drive form. Recently, the solid state drive is packaged in a small-sized module or chip in order to improve utilization and replace the hard disk drive (HDD). As known, the conventional solid state drive is a single storage device using a SATA (Serial Advanced Technology Attachment) interface. That is, a single port is only able to connect and identify a single storage device. In case that a system permits multiple users to access a solid state drive, two approaches are usually adopted. The first approach is directed to an account management method. In accordance with the account management method, the amount of the available storage space and the access authority for each user are managed by the system administrator of the operation system. The second approach is directed to a multi-boot method. According to the multi-boot method, a single solid state drive is partitioned into at most four primary partition regions for different users.

However, the above two approaches of managing the access of the solid state drive still have some drawbacks. For example, if the solid state drive is used in a low-level system or the solid state drive is used as an external data storage device, the solid state drive may be externally accessible or the solid state drive may be accessed through software cracking. In other words, the data security performance is usually unsatisfied. Moreover, since a single solid state drive is only logically partitioned into at most four primary partition regions, the system management is limited and the hardware cost is high.

### SUMMARY OF THE INVENTION

An object of the present invention provides a data storage device and a control method for the data storage device in order to overcome the drawbacks of the conventional technologies. A control unit of the solid state drive re-partitions the NAND flash memory into plural physical accessing blocks. Consequently, the number and size of the physical accessing blocks can be determined according to the practical requirements.

In accordance with an aspect of the present invention, there is provided a data storage device. The data storage device includes a physical storage unit, an authentication unit and a control unit. The authentication unit has a unique identification code. The control unit is electrically connected with the physical storage unit and configured to receive an identification command corresponding to the unique identification code. When the control unit receives the identification command, the control unit generates a logical block starting address and an available space according to the identification command, and determines a specified physical accessing block of plural physical accessing blocks of the physical storage unit according to the logical block starting address and the available space. The logical block starting address is a positive integer. In addition, a size of the physical accessing block is smaller than or equal to a size of the physical storage unit.

In an embodiment, the physical storage unit is a NAND flash memory or a disk of a hard drive.

In an embodiment, the control unit is a controller.

In an embodiment, the authentication unit is a USB flash drive or a memory card.

In an embodiment, the data storage device further includes a detecting/reading unit. The detecting/reading unit is electrically connected with the control unit for detecting or reading the unique identification code of the authentication unit and transmitting the unique identification code to the control unit.

In an embodiment, the detecting/reading unit is a radio frequency identification reader, and the authentication unit is a radio frequency identification tag.

In an embodiment, the detecting/reading unit is a barcode scanner, a fingerprint sensor or an iris sensor.

In an embodiment, a number of the plural physical accessing blocks is larger than or equal to 4.

In accordance with an aspect of the present invention, there is provided a data storage device. The data storage device includes a physical storage unit and a control unit. The control unit is electrically connected with the physical storage unit. The control unit generates plural logical block starting addresses and plural corresponding available spaces according to a control command, and determines plural physical accessing blocks of the physical storage unit according to the plural logical block starting addresses and the plural available spaces.

In an embodiment, the plural physical accessing blocks correspond to plural unique identification codes, respectively, and the plural unique identification codes are stored in the control unit.

In an embodiment, according to an identification command containing one of the plural unique identification codes, the control unit accesses a corresponding physical accessing block of the plural physical accessing blocks.

In an embodiment, the data storage device further comprises an electronic device. The electronic device receives the unique identification code and generates the identification command corresponding to the unique identification code.

In accordance with a further aspect of the present invention, there is provided a control method for a data storage device including a control unit, an authentication unit and a physical storage unit. The control method includes the following steps. Firstly, an identification command is generated according to a unique identification code. Then, a logical block starting address and an available space are generated according to the identification command. Then, a specified physical accessing block of plural physical accessing blocks of the physical storage unit is determined according to the logical block starting address and the available space. Afterwards, an accessing action is performed on the specified physical accessing block. The accessing action includes a file reading/writing action or an action of formatting the specified physical accessing block.

In an embodiment, the control method further includes a step of receiving the unique identification code from the authentication unit by the control unit.

In an embodiment, the authentication unit is a USB flash drive or a memory card.

In an embodiment, the control method further includes a step of using a detecting/reading unit to detect or read the unique identification code of the authentication unit and transmit the unique identification code to the control unit.

In an embodiment, the detecting/reading unit is a radio frequency identification reader, and the authentication unit is a radio frequency identification tag.

In an embodiment, the detecting/reading unit is a barcode scanner, a fingerprint sensor or an iris sensor.

From the above descriptions, the present invention provides a data storage device and a control method for the data storage device. By the control method of the present invention, a physical storage unit of the data storage device is partitioned into plural physical accessing blocks. Consequently, the single data storage device is shared by multiple users. Under this circumstance, the limitation of the system management and the hardware cost are both reduced. Since the physical accessing block is accessed according to the corresponding unique identification code, the data security performance of the data storage device is largely enhanced.

The above contents of the present invention will become more readily apparent to those ordinarily skilled in the art after reviewing the following detailed description and accompanying drawings, in which:

### BRIEF DESCRIPTION OF THE DRAWINGS

FIG. 1 is a schematic functional block diagram illustrating a data storage device according to a first embodiment of the present invention;

FIG. 2 schematically illustrates the implementing concepts of the data storage device of FIG. 1;

FIG. 3 is a schematic functional block diagram illustrating a variant embodiment of the data storage device of FIG. 1;

FIG. 4 schematically illustrates the implementing concepts of the data storage device of FIG. 3;

FIG. 5 is a schematic functional block diagram illustrating a data storage device according to a second embodiment of the present invention;

FIG. 6A schematically illustrates the original settings of the physical storage unit of the data storage device according to the second embodiment of the present invention;

FIG. 6B schematically illustrates the implementing concepts of the data storage device of FIG. 6A;

FIG. 6C schematically illustrates the new settings of the physical storage unit of the data storage device according to the second embodiment of the present invention;

FIG. 6D schematically illustrates the implementing concepts of the data storage device of FIG. 6C; and

FIG. 7 is a flowchart illustrating a control method for a data storage device according to an embodiment of the present invention.

### DETAILED DESCRIPTION OF THE PREFERRED EMBODIMENT

The present invention will now be described more specifically with reference to the following embodiments. It is to be noted that the following descriptions of preferred embodiments of this invention are presented herein for purpose of illustration and description only. In the following embodiments and drawings, the elements irrelevant to the concepts of the present invention are omitted and not shown. For well understanding the present invention, the elements shown in the drawings are not in scale with the elements of the practical product.

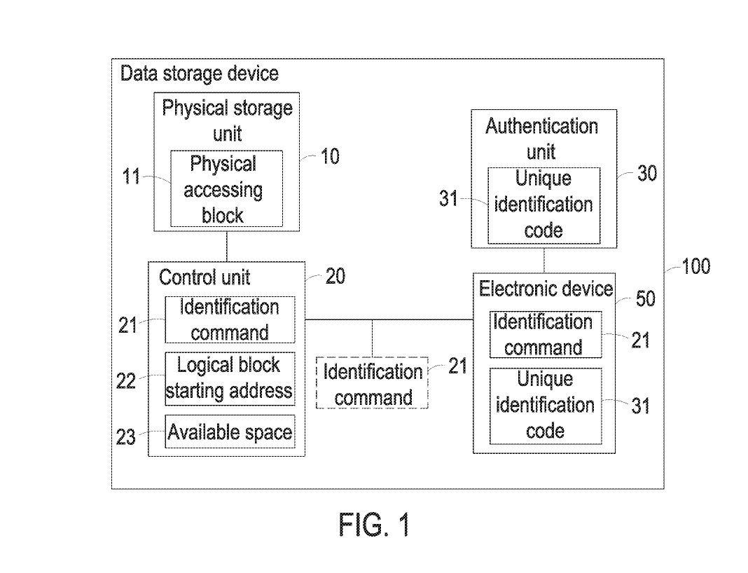

FIG. 1 is a schematic functional block diagram illustrating a data storage device according to a first embodiment of the present invention. As shown in FIG. 1, the data storage device 100 comprises a physical storage unit 10, a control unit 20 and an authentication unit 30. In an embodiment, the physical storage unit 10 is a NAND flash memory or a disk of a hard drive, the control unit 20 is a controller, and the authentication unit 30 is a USB flash drive or a memory card that stores a unique identification code 31. The control unit 20 is electrically connected with the physical storage unit 10.

The data storage device 100 is electrically connected with an electronic device 50. For example, the electronic device 50 is a personal computer, a notebook computer or a workstation. When an accessing command from the electronic device 50 is received by the control unit 20, the control unit 20 accesses a data from the physical storage unit 10 and transfers the data to the electronic device 50. The authentication unit 30 is connected with the electronic device 50 through a corresponding connecting port such as a USB port or card reader. Consequently, an identification command 21 containing the unique identification code 31 of the authentication unit 30 is transmitted to the control unit 20 through the electronic device 50.

According to the identification command 21, the control unit 20 generates a default logical block starting address 22 and an available space 23. Moreover, the control unit 20 determines a physical accessing block 11 of the physical storage unit 10 according to the logical block starting address 22 and the available space 23. In an embodiment, the logical block starting address 22 is a positive integer, and the size of the physical accessing block 11 is smaller than or equal to the size of the physical storage unit 10.

As previously described, the conventional solid state drive can be partitioned into at most four primary partition regions. In accordance with the present invention, the number of the physical accessing blocks 11 is larger than or equal to 4. The physical accessing block 11 is equivalent to the primary partition region of the conventional solid state drive. In other words, the technology of the present invention is more flexible than the conventional technology. Moreover, after the authentication unit 30 owned by a specified user is plugged into the electronic device 50, the user is only able to access the corresponding physical accessing block 11 of the physical storage unit 10 according to the unique identification code 31 of the authentication unit 30. Moreover, the user of the authentication unit 30 cannot realize whether other physical accessing blocks 11 exist in the physical storage unit 10 or even cannot access or pry about the data of other physical accessing blocks 11. Consequently, the data security performance of the data storage device 100 is largely enhanced.

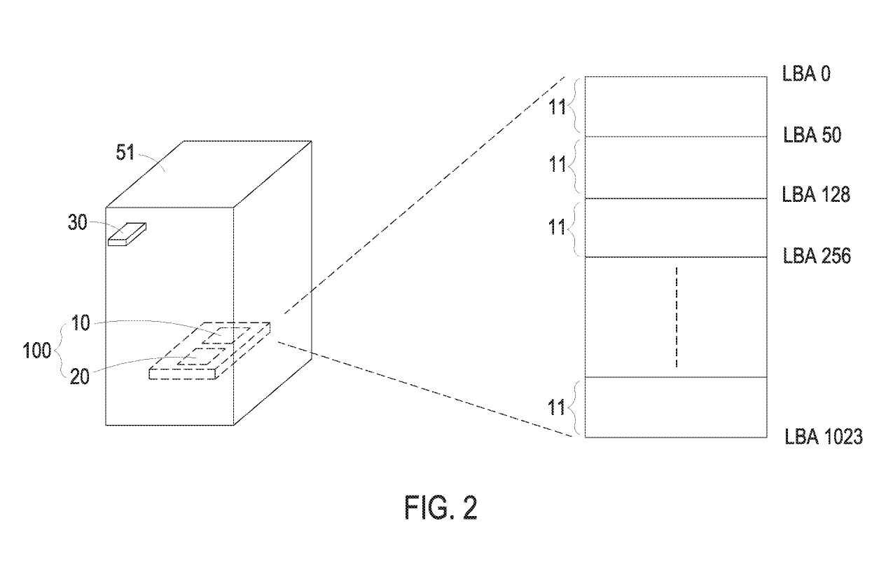

FIG. 2 schematically illustrates the implementing concepts of the data storage device of FIG. 1. In this embodiment, the data storage device 100 is a solid state drive. Moreover, the physical storage unit 10 is a NAND flash memory, the control unit 20 is a controller, and the authentication unit 30 is a USB flash drive. As shown in FIG. 2, the physical storage unit 10 comprise 1024 logical block addresses LBA0˜LBA1023. The logical block address LBA0 corresponds to a first accessible logical block. The logical block address LBA1 corresponds to the second accessible logical block. The logical block address LBA1023 corresponds to the 1024-th accessible logical block. The rest may be deduced by analogy. The logical block addressing technology is well known to those skilled in the art, and is not redundantly described herein.

After the authentication unit 30 is plugged into the USB port of a computer host 51, a booting process is performed. During the booting process, the computer host 51 generates the identification command 21 according to the unique identification code 31 of the authentication unit 30. After the identification command 21 is transmitted to the control unit 20, the control unit 20 accesses the corresponding physical accessing block 11 of the physical storage unit 10 according to the unique identification code 31. Preferably but not exclusively, the logical block starting address 22 and the available space 23 of the physical accessing block 11 corresponding to each unique identification code 31 are previously stored in the control unit 20.

In particular, the physical accessing block 11 to be accessed is determined according to the logical block starting address 22 and the available space 23. For example, in case that the default logical block starting address 22 is LBA50 and the default available space 23 is 78, the physical accessing block 11 contains 78 logical blocks, i.e., LAB50˜LBA127. In this embodiment, the available space 23 is expressed by a specified number of logical blocks. Alternatively, in another embodiment, the available space 23 is expressed by a specified size of accessing space (e.g., 10 GB).

Moreover, when a write command from the operation system of the computer host 51 is transmitted to the data storage device 100, the control unit 20 acquires an address (e.g., LBA10) of the physical storage unit 10 corresponding to the write command. Then, the control unit 20 adds this address (i.e., LBA10) and the logical block starting address 22 (i.e., LBA50) to obtain LBA60. In other words, the data will be written into the address of the logical block LBA60.

From the above descriptions, the computer host 51 provides a specified physical accessing block 11 to a specified user according to the specified unique identification code 31. More specially, the specified user has the super user authority of the specified physical accessing block 11 to reinstall the system, format the specified physical accessing block 11 or perform any other appropriate administrating action.

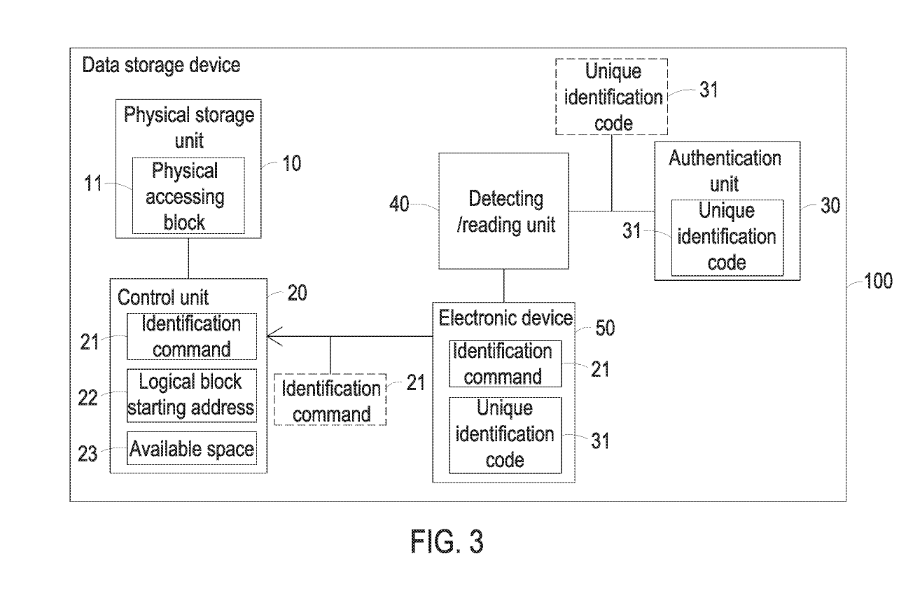

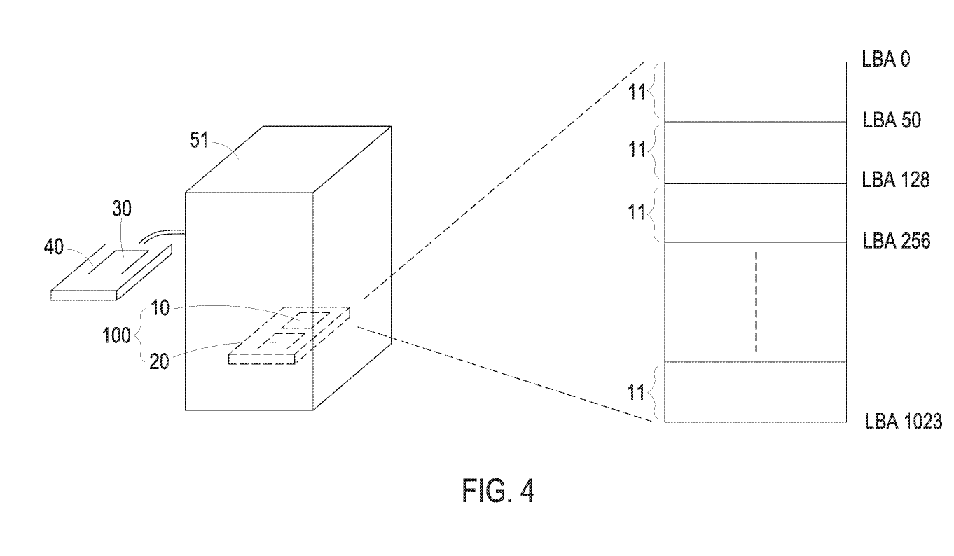

FIG. 3 is a schematic functional block diagram illustrating a variant embodiment of the data storage device of FIG. 1. FIG. 4 schematically illustrates the implementing concepts of the data storage device of FIG. 3. In comparison with the above-described embodiment, the data storage device 100 of this embodiment further comprises a detecting/reading unit 40. The detecting/reading unit 40 is electrically connected with the control unit 20. The detecting/reading unit 40 is used for detecting or reading the unique identification code 31 of the authentication unit 30 and transmitting the unique identification code 31 to the control unit 20. An example of the detecting/reading unit 40 includes but is not limited to a radio frequency identification (RFID) reader, a barcode scanner, a fingerprint sensor or an iris sensor.

As shown in FIG. 4, in this embodiment, the data storage device 100 is a solid state drive. Moreover, the physical storage unit 10 is a NAND flash memory, the control unit 20 is a controller, the authentication unit 30 is a RFID tag, and the detecting/reading unit 40 is a RFID reader.

After the detecting/reading unit 40 is connected with the USB port of a computer host 51 and the authentication unit 30 is placed with an effective detecting range of the detecting/reading unit 40, a booting process is performed. After the booting process is completed, the unique identification code 31 detected by the detecting/reading unit 40 is directly transmitted to the computer host 51. Then, the unique identification code 31 is transmitted from the computer host 51 to the control unit 20 of the data storage device 100.

Then, the control unit 20 generates a logical block starting address 22 and an available space 23 corresponding to the unique identification code 31. Consequently, the physical accessing block 11 to be accessed is determined according to the logical block starting address 22 and the available space 23. The way of generating the physical accessing block 11 is similar to that mentioned above, and is not redundantly described herein.

In this embodiment, the data storage device can be applied to a computer classroom or a laboratory. By means of the data storage device, multiple users can use the same computer during different time segments. Moreover, each of the multiple users possesses the authentication unit 30 with the unique identification code 31. That is, a specified user can access the corresponding physical accessing block by using the unique identification code. Similarly, the specified user has the super user authority of accessing the specified physical accessing block. Similarly, the number of the physical accessing blocks is larger than or equal to 4.

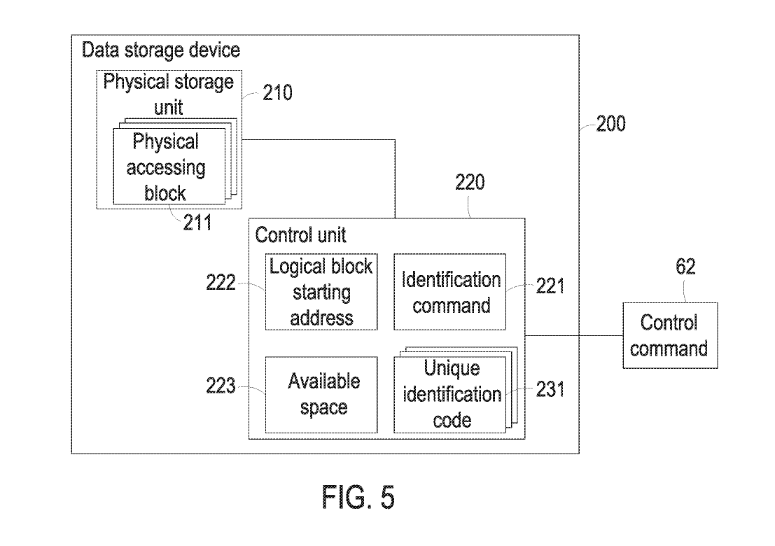

FIG. 5 is a schematic functional block diagram illustrating a data storage device according to a second embodiment of the present invention. As shown in FIG. 5, the data storage device 200 comprises a physical storage unit 210 and a control unit 220. In an embodiment, the physical storage unit 210 is a NAND flash memory or a disk of a hard drive, and the control unit 220 is a controller. The control unit 220 is electrically connected with the physical storage unit 210. Moreover, the data storage device 200 is electrically connected with a computer host. When a control command 62 from the computer host is received by the data storage device 200, the control unit 220 partitions the physical storage unit 210 into plural physical accessing blocks 211 according to the control command 62. The control command 62 contains plural logical block starting addresses 222, plural available spaces 223 and plural unique identification codes 231.

While the control unit 220 partitions the physical storage unit 210 into the plural physical accessing blocks 211 according to the control command 62, the control unit 220 only needs to store the plural unique identification codes 231, the corresponding logical block starting addresses 222 and the corresponding available spaces 223.

As mentioned above, when the control unit 200 receives a unique identification code 231, the control unit 200 generates an identification command 221. According to the identification command 221, the control unit 220 generates a default logical block starting address 222 and a default available space 223. Moreover, the control unit 200 determines a physical accessing block 211 according to the logical block starting address 222 and the available space 223. The logical block addressing technology has been described as above, and is not redundantly described herein.

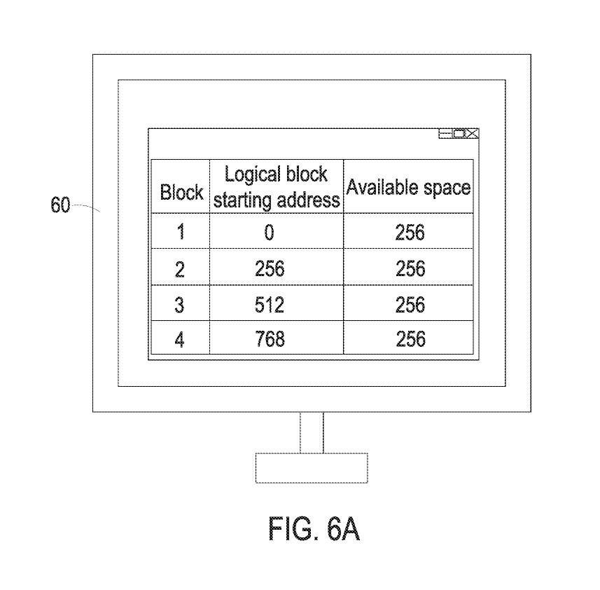

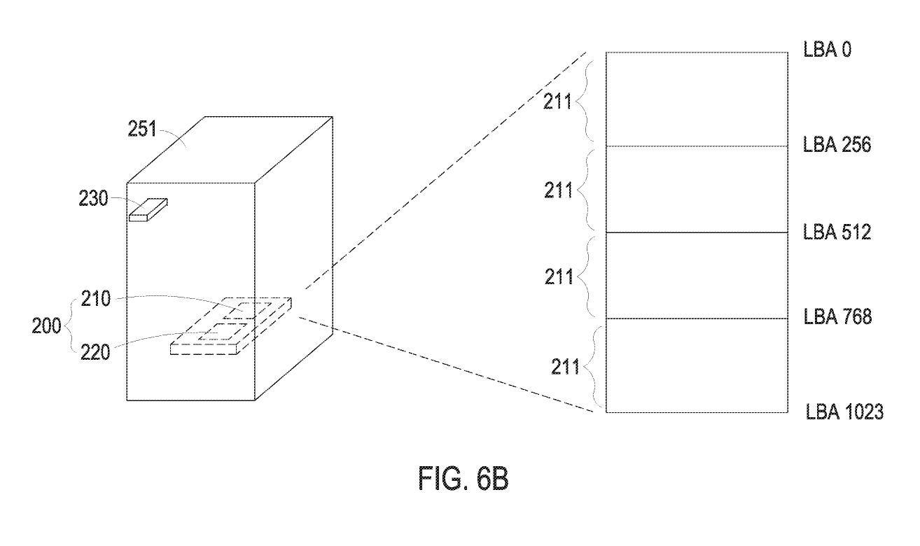

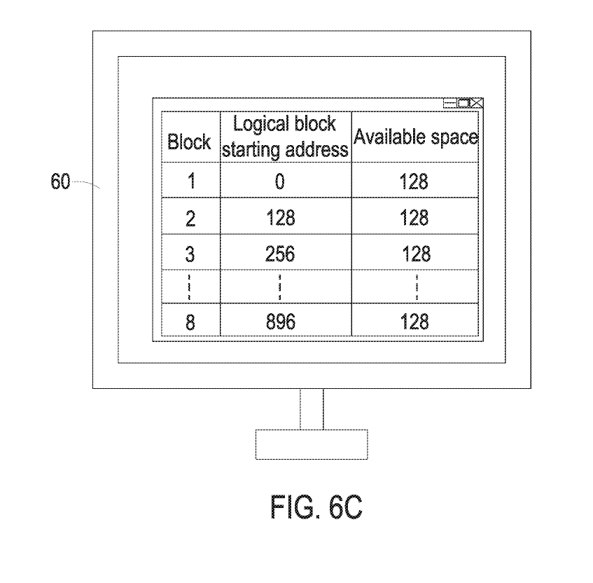

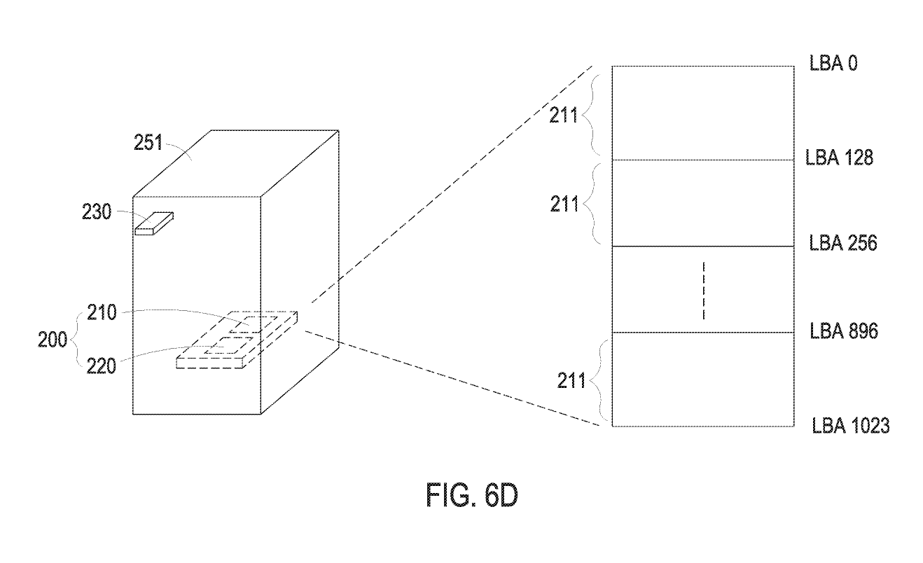

The operations of the data storage device according to the second embodiment of the present invention will be illustrated with reference to FIG. 5 and FIGS. 6A to 6D.

In this embodiment, the data storage device 200 is a solid state drive, and the size of the physical storage unit 210 is 1 TB. The data storage device 200 is electrically connected with a computer host 251. Since the present invention is directed to a method of re-partitioning the physical storage unit 210 of the data storage device 200, the method of partitioning the physical storage unit 210 is performed before a basic input/output system (BIOS) is loaded into a boot sector.

For example, after an authentication unit 230 containing a system identification code is plugged into the computer host 251, a booting process is performed. During the booting process, the BIOS system authenticates the system identification code and notifies the control unit 220. Consequently, the user can perform the action of partitioning the physical storage unit 210. By using the system identification code, the user has a complete authority to modify the physical storage unit 210. It is noted that the user can possess the complete authority by using other methods. For example, during the booting process of the computer host 251, a pop-up window is created to request the user to input a password into the window. If the inputted password is authenticated, the computer host 251 executes an application program to guide the user to partition the physical storage unit 210.

A process of partitioning the physical storage unit 210 through the computer host 251 will be illustrated as follows. Firstly, the application program for guiding the user to partition the physical storage unit 210 is activated. Consequently, the user realizes the size of the physical storage unit 210. As shown in FIG. 6A, the size of the physical storage unit 210 is displayed on a display screen 60 that is in communication with the computer host 251. In particular, the logical block starting addresses and the available spaces of four physical accessing blocks 211 are displayed on the display screen 60. In this embodiment, the sizes of these four physical accessing blocks 211 are equal (e.g., 250 GB). As shown in FIG. 6B, the logical block addresses of the four physical accessing blocks 211 are LBA0˜LBA255, LBA256˜LBA511, LBA512˜LBA767 and LBA768˜LBA1023, respectively.

Then, the user can modify the size of the physical accessing blocks 211 of the data storage device 200 through the application program. As shown in FIG. 6C, the logical block starting addresses and the available spaces of eight physical accessing blocks 211 are displayed on the display screen 60 according to the new settings. The logical block addresses of the corresponding physical accessing blocks 211 are shown in FIG. 6D. By the partitioning process of the present invention, the number of the physical accessing blocks 211 is larger than or equal to 4. Moreover, the unique identification codes 231 corresponding to the plural physical accessing blocks 211 are stored in the control unit 220.

After the above partitioning process is completed, multiple users can access the designated physical accessing blocks 211, respectively. For example, when the control unit 200 receives a unique identification code 231 of a specified user, the control units 200 generates a corresponding identification command 221. According to the identification command 221, the control unit 220 generates a logical block starting address 222 and an available space 223. The physical accessing block 211 to be accessed is determined according to the logical block starting address 222 and the available space 223. For example, the addresses of the physical accessing block 211 are in the range between LAB128 and LBA257. The way of generating the physical accessing block 211 is similar to that mentioned above, and is not redundantly described herein.

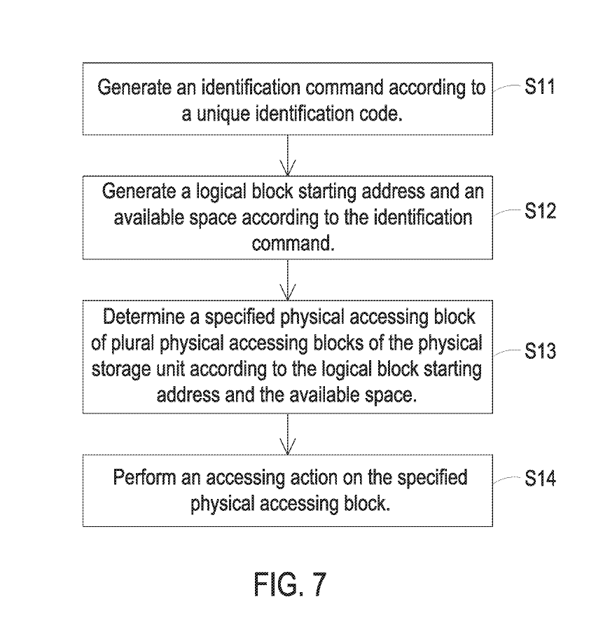

FIG. 7 is a flowchart illustrating a control method for a data storage device according to an embodiment of the present invention. The data storage device comprises a control unit, an authentication unit and a physical storage unit. The control method comprises the following steps.

In a step S11, an identification command is generated according to a unique identification code.

In a step S12, a logical block starting address and an available space are obtained according to the identification command, wherein the logical block starting address and the available space are previously stored in the control unit.

In a step S13, a physical accessing block of the physical storage unit is determined according to the logical block starting address and the available space.

In a step S14, an accessing action is performed on the physical accessing block, wherein the accessing action includes a file reading/writing action or an action of formatting the physical accessing block.

The control method further comprises a step of receiving the unique identification code from the authentication unit by the control unit. For example, the authentication unit is a USB flash drive or a memory card.

The control method further comprises a step of using a detecting/reading unit to detect or read the unique identification code of the authentication unit and transmit the unique identification code to the control unit. In an embodiment, the detecting/reading unit is a RFID reader, and the authentication unit is a RFID tag. In another embodiment, the detecting/reading unit is a barcode scanner, a fingerprint sensor or an iris sensor, and the authentication unit is a barcode, a fingerprint or an iris.

From the above descriptions, the present invention provides a data storage device and a control method for the data storage device. By the control method of the present invention, a physical storage unit of the data storage device is partitioned into plural physical accessing blocks. Consequently, the single data storage device is shared by multiple users. Under this circumstance, the limitation of the system management and the hardware cost are both reduced. Moreover, since the physical accessing block is accessed according to the corresponding unique identification code, the data security performance of the data storage device is largely enhanced. In other words, the system management is simplified, the multi-boot method is achievable and the data security performance is enhanced.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A data storage device, comprising:
a physical storage unit;
an authentication unit with a unique identification code; and
a control unit electrically connected with the physical storage unit and configured to receive an identification command corresponding to the unique identification code, wherein when the control unit receives the identification command, the control unit generates a logical block starting address and an available space according to the identification command, and determines a specified physical accessing block of plural physical accessing blocks of the physical storage unit according to the logical block starting address and the available space, wherein the logical block starting address is a positive integer, and a size of the physical accessing block is smaller than or equal to a size of the physical storage unit.

2. The data storage device according to claim 1, wherein the physical storage unit is a NAND flash memory or a disk of a hard drive.

3. The data storage device according to claim 1, wherein the control unit is a controller.

4. The data storage device according to claim 1, wherein the authentication unit is a USB flash drive or a memory card.

5. The data storage device according to claim 1, further comprising a detecting/reading unit, wherein the detecting/reading unit is electrically connected with the control unit for detecting or reading the unique identification code of the authentication unit and transmitting the unique identification code to the control unit.

6. The data storage device according to claim 5, wherein the detecting/reading unit is a radio frequency identification reader, and the authentication unit is a radio frequency identification tag.

7. The data storage device according to claim 5, wherein the detecting/reading unit is a barcode scanner, a fingerprint sensor or an iris sensor.

8. The data storage device according to claim 1, wherein a number of the plural physical accessing blocks is larger than or equal to 4.

9. The data storage device according to claim 1, further comprising an electronic device, wherein the electronic device receives the unique identification code and generates the identification command corresponding to the unique identification code.

10. A data storage device, comprising:
a physical storage unit; and
a control unit electrically connected with the physical storage unit, wherein the control unit generates plural logical block starting addresses and plural corresponding available spaces according to a control command, and determines plural physical accessing blocks of the physical storage unit according to the plural logical block starting addresses and the plural available spaces.

11. The data storage device according to claim 10, wherein the plural physical accessing blocks correspond to plural unique identification codes, respectively, and the plural unique identification codes are stored in the control unit.

12. The data storage device according to claim 11, wherein according to an identification command containing one of the plural unique identification codes, the control unit accesses a corresponding physical accessing block of the plural physical accessing blocks.

13. A control method for a data storage device including a control unit, an authentication unit and a physical storage unit, the control method comprising steps of:
generating an identification command according to a unique identification code;
generating a logical block starting address and an available space according to the identification command;
determining a specified physical accessing block of plural physical accessing blocks of the physical storage unit according to the logical block starting address and the available space; and
performing an accessing action on the specified physical accessing block, wherein the accessing action includes a file reading/writing action or an action of formatting the specified physical accessing block.

14. The control method according to claim 13, further comprising a step of receiving the unique identification code from the authentication unit by the control unit.

15. The control method according to claim 14, wherein the authentication unit is a USB flash drive or a memory card.

16. The control method according to claim 14, further comprising a step of using a detecting/reading unit to detect or read the unique identification code of the authentication unit and transmit the unique identification code to the control unit.

17. The control method according to claim 16, wherein the detecting/reading unit is a radio frequency identification reader, and the authentication unit is a radio frequency identification tag.

18. The control method according to claim 16, wherein the detecting/reading unit is a barcode scanner, a fingerprint sensor or an iris sensor.
